(19) United States
(12) Patent Application Publication
(10) Pub. No.: US 2017/0307464 A1
(43) Pub. Date: Oct. 26, 2017

(54) Acoustic Leak Detector

(71) Applicant: Microphonon, Inc., Albuqerque, NM (US)

(72) Inventors: Michael P. Hasselbeck, Albuquerque, NM (US); Benno J. A. Ritter, San Carlos, CA (US)

(21) Appl. No.: 15/454,930

(22) Filed: Mar. 9, 2017

Related U.S. Application Data
(60) Provisional application No. 62/373,342, filed on Aug. 10, 2016.
(60) Provisional application No. 62/326,743, filed on Apr. 23, 2016.

(51) Int. Cl. G01M 3/24

(52) U.S. Cl. CPC G01M 3/24

(57) ABSTRACT

A sensor based audio and ultrasonic water leak detection and localization system is disclosed. The system is able to detect leaks through building structures such as walls. No direct contact with water or plumbing is necessary, enabling remote monitoring. An embodiment of the system includes multiple, spatially separated sensor units to provide a distributed mapping network for additional accuracy. Long term data acquired from individual but otherwise identical sound collection devices contain statistical information that indicates the strength of the leak source and hence its separation from the detector. This information assists in triangulating to the leak source.

### RELATED APPLICATIONS

This application claims priority from U.S. Provisional Application Ser. No. 62/373,342 filed Aug. 10, 2016, and U.S. Provisional Application Ser. No. 62/326,743 filed Apr. 23, 2016. The disclosures of each of these applications are incorporated herein by reference.

### TECHNICAL FIELD

The technical field is water leak and water flow detection and its implementation in smart home and building automation.

### BACKGROUND

Undetected water leaks represent a significant risk to building property owners. If left unchecked, damage to the structure and its contents is likely to occur. There are also utility costs associated with excessive water consumption, including the possibility of fines in regions of restricted water use.

Most of the currently available sensors require direct contact with leaking water or are inserted into plumbing. Inline flow meters are used by the water utility to monitor customer usage, but these are typically read by a field technician and only monthly. Inline smart meters cannot localize a leak or recognize small leaks. Infrequent meter readings may identify leaks only after catastrophic water loss has occurred. Inline meters with radio links to the utility are becoming available, but these still require vigilant monitoring to be effective for leak detection. The main water line can be retrofitted with an inline meter that reports data to the consumer, but these are expensive and require cutting into the pipe. Inline meters are also known to be unreliable at flow rates below 0.2 gallons per minute. Low-flow accuracy degrades with long term use due to the build-up of sediment in the flow transducer.

Non-invasive flow and water detectors are possible. Sensors can be placed in strategic areas near plumbing where water may be expected to accumulate in the event of a leak. An alarm is triggered when the physical presence of water is sensed. Sensors are deployed in low spots that may be disturbed and/or activated by nominal house cleaning activities or foot traffic. Furthermore, such sensors are unlikely to be effective in attics, crawlspaces, or locations where the potential pooling of water is difficult to identify and access. A humidity sensor may not trigger until a catastrophic amount of water has escaped.

A vibration sensor can be attached to a pipe to monitor signals in the certain frequency range. Water flow and leaks are known to induce such vibrations. A difficulty of implementing this approach is combating the 1/f noise associated with normal background vibrations and acoustics. This can push the signal-to-noise ratio low enough that this scheme is unreliable in all but the quietest environments. Leaks on the order of 1 gallon/minute and smaller may not detectable.

Audio and ultrasonic frequency detection and localization of leaks has been practiced for more than a century. A simple stethoscope placed on a pipe can be effective for troubleshooting leak situations. In the last two decades, more sensitive portable acoustic leak detectors have become available. These require a trained technician to make field readings and interpret the data. U.S. Pat. No. 8,489,342 describes a non-invasive water flow sensor comprising an ultrasonic emitter/detector pair. U.S. Pat. No. 8,193,942 is another implementation of a non-invasive, strap-on device that may use a microphone to listen for disturbances associated with water flow in a pipe. Both systems require continuous operation of microphone and audio electronics, resulting in high power consumption. High power consumption drains battery life to the extent that the battery lifetime fails to meet the applicable wireless protocol's standard requirements.

In short, existing sensors have no capability for power-efficient, remote, stand-off detection of water leaks, and cannot detect leaks through building structures, such as walls, ceilings etc. Even if leak is sensed, very few existing systems have automated shut-off valves.

### SUMMARY

This disclosure enables sensor based audio and ultrasonic water leak detection and localization quickly from a distance. The system is able to detect leaks through building structures such as walls. No direct contact with water or plumbing is necessary. The system may activate a shut-off valve to prevent further water leaks. The sensor may also be used to detect the escape of other pressurized fluids and gases by making modifications within the scope of this disclosure.

In one aspect of the disclosure, a method is disclosed for detecting the presence of pressurized water escaping from an orifice such as a crack in a pipe or flowing from a plumbing fixture. An example of such a fixture is an irrigation head. The method can be optimized for processing of acoustic signals in a specific frequency range, for example, 8-12 kHz. These signals can propagate a significant distance in free-space to enable stand-off detection, where a sensor can be located remotely from the plumbing, i.e. on a nearby wall or ceiling. It can be powered by a battery and achieve an operational lifetime of multiple years using readily available, low cost components. This method is compatible with, but not limited to, low duty-cycle, low-power consumption, and a variety of wireless protocols.

In another aspect, the present method includes one or more directional sound collection devices. A sound collection device that includes an acoustic transducer, such as a microphone or any other sound detector, placed at the focus of an on-axis or off-axis curved reflector (e.g., a parabolic reflector) is well suited for this application.

One embodiment includes multiple parabolic collectors that help identify: i) the presence of a pressurized water leak and ii) its direction from the sensor location. The angular resolution is determined by the number of collectors, their spatial arrangement, and the diameter of the parabolic reflectors.

Another embodiment of this method includes multiple, spatially separated sensor units to provide a distributed mapping network for additional accuracy. Long-term data acquired from individual but otherwise identical sound collection devices contain statistical information that indicates the strength of the leak source and hence its separation from the detector. As an example, a detector that registers 90% detected events in a specified time window is in closer proximity to a leak than an identical detector that accumulates at a rate of 50% in the same time period. This information assists in triangulating to the leak source.

Different sensor types (temperature, smoke, carbon monoxide, humidity, motion, etc) can be incorporated in the device housing to implement a multi-function sensor suite.

### BRIEF DESCRIPTION OF THE DRAWINGS

These and other aspects and features of the present disclosure will become apparent to those ordinarily skilled in the art upon review of the following description of specific embodiments in conjunction with the accompanying figures, wherein:

FIG. 1 illustrates a flow chart of a method implemented by a leak detection system, according to an embodiment;

FIG. 2 illustrates a sensor block diagram, according to an embodiment—the center frequency and spectral width of the acoustic filter are not critical;

FIG. 3 illustrates a block diagram of a method for directional acoustic leak detection, according to an embodiment. Signals are routed sequentially to the control electronics with a multiplexer under the control of the MCU. For purposes of illustration only, four sound collection devices are shown. More or fewer could be implemented depending on the application.

### DETAILED DESCRIPTION

The embodiments are described in detail with reference to the drawings, which are provided as illustrative examples so as to enable those skilled in the art to practice the disclosure. Notably, the figures and examples below are not meant to limit the scope of the embodiments to a single embodiment, but other embodiments are possible by way of interchange of some or all of the described or illustrated elements. Moreover, where certain elements of the embodiments can be partially or fully implemented using known components, only those portions of such known components that are necessary for an understanding of the embodiments will be described, and detailed descriptions of other portions of such known components will be omitted so as not to obscure the disclosure.

Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the disclosure is intended to encompass other embodiments including a plurality of the same component, and vice-versa, unless explicitly stated otherwise herein.

Moreover, applicants do not intend for any term in the specification or claims to be ascribed an uncommon or special meaning unless explicitly set forth as such. Further, the present disclosure encompasses present and future known equivalents to the known components referred to herein by way of illustration.

A method is disclosed for detecting the presence of pressurized water escaping from an orifice such as a crack in a pipe or flowing from a plumbing fixture, such as an irrigation head or a leak in household plumbing. It functions by processing acoustic signals in the frequency range 8-12 kHz. These signals can propagate a significant distance in free-space to enable stand-off detection; a sensor can be located remotely from the plumbing, i.e. on a nearby wall or ceiling. This method is compatible with, but not limited to, low duty-cycle, low-power consumption, low data-rate wireless protocols, such as, Zigbee, Z-wave, and Bluetooth LE among others.

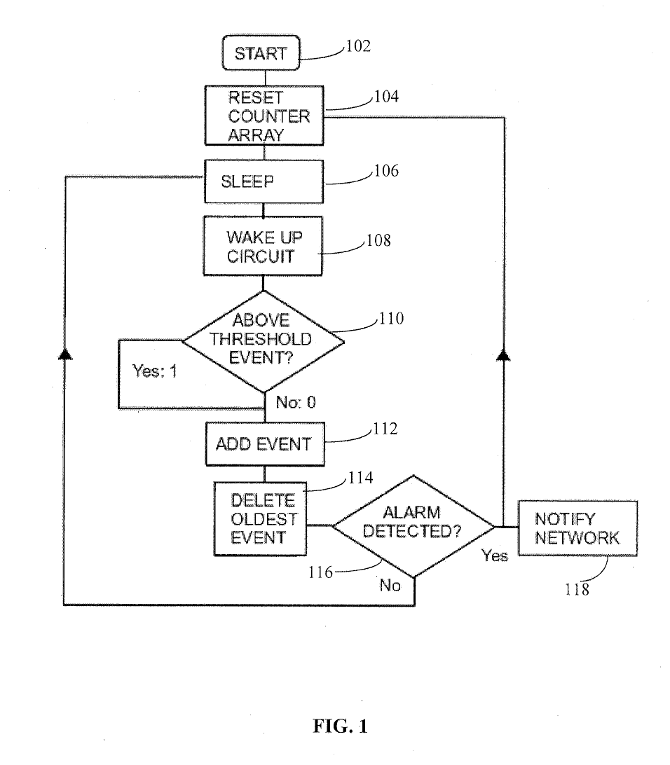

A flow chart of the device method of operation is shown in FIG. 1. This control program for implementing the method resides in the non-volatile flash memory firmware of a micro-controller unit (MCU).

A generic MCU can perform this function with minimal continuous current draw. The MCU may be a part of a control electronics module, that comprises, among other things, an audio amplifier, high-pass or band-pass filter, rectification electronics, MCU, and, network hardware.

To conserve power, the circuit is periodically activated to acquire an acoustic signal, process it, and interpret it for a leak condition. An acoustic transducer, such as a microphone, is placed in the vicinity of the plumbing or plumbing appliances. When a leak occurs, a broadband acoustic signal emits as high pressure water passes through the flow orifice. There can be significant signal strength at certain frequencies, where the detector sensitivity is optimized. For example, in a particular embodiment, sensitivity can be optimized for frequencies >8 kHz. An example of such a signal is water flowing in a controlled manner through a faucet valve. The acoustic signal can radiate into surrounding air and be detected by the sensor at distances of a meter or more, depending on the flow rate, aperture geometry, and quality of the acoustic path. The signal is amplified and sent through a spectral filter to remove background acoustics. It is then rectified to change the fluctuating AC signal to a steady DC voltage. The DC signal is fed to a comparator that determines if a preset voltage level has been exceeded. This threshold corresponds to an acoustic signal amplitude within the filter passband that is consistent with a leak.

There is an event counter in the circuit. Upon power up, all elements in the event counter 1-dimensional array are set to zero and the active circuit enters the sleep mode. This is shown in steps 102, 104 and 106 in FIG. 1. Sleep mode is the time period when all the electronic circuitry with the exception of the MCU low power clock is off. Conversely, active mode is the time period when MCU and its central processing unit (CPU) along with sensor electronics are up and running. For the purpose of illustration, the sleep time is 10 s although it is understood that any time duration may be suitable depending on the specific application. The counter array holds the most recent history of acoustic events; the array size is limited by available random access memory. A programmed timer interrupt places the MCU in active mode and power is applied to the entire circuit. The acoustic sensor collects a signal from the ambient environment, amplifies and rectifies it, then evaluates the voltage amplitude using a comparator. The acoustic sensor may comprise a microelectromechanical (MEMS) microphone, a piezoelectric transducer, an electret condenser microphone, or other type of sound collectors. If the signal is above a preset threshold voltage, the current counter array element is set to 1; otherwise it is set to zero. This is shown in steps 110 and 112. The oldest element in the event array is discarded and the array is summed (step 114). The circuit then goes back into the low-power sleep mode unless an alarm condition is identified in step 116. The duration of the active state of the circuit depends on circuit response time and the desired signal sampling time at the acoustic frequencies of interest.

If the sum of array elements, each having a value of either 0 or 1, exceeds a programmed integer value, then a leak condition is identified and the network is notified of an alarm (step 118). The total number of summed events is set in the program to be consistent with an anomalous water flow condition; this might be 1 hour for a single-family residence. A persistent leak signal over this extended time window is unlikely to result from normal usage. As an example, a 10 second sampling interval and a 1-hour time window defines an array size of 360 saved events. Not all array elements need to be 1 for an alarm condition; this allows for occasional below threshold signals that occur with weak, intermittent water leaks or temporary drops in water pressure. The array holds a binary record (TRUE=1, FALSE=0) of the most recent acoustic samplings.

It is understood that with momentary, periodic sensor activation, the onset and cessation of a leak or flow cannot be determined with precision. The temporal resolution is determined by the OFF or sleep period. The sleep period is a system parameter whose value may vary. The value of sleep period can be set to be 10 s, for example. This is the trade-off the design makes to have very long battery life. A sampling inaccuracy of ±10 s over a time window of 1 hour, however, is of little consequence.

In summary, the illustrative method in FIG. 1 has the following steps. The method starts at step 102. The counter array for a single input or multiple arrays for multiple inputs are reset at step 104. In step 106, the sleep period is set. The sensor automatically wakes up at a set interval, as shown in step 108. If the detected acoustic signal is above preset threshold, then it is recorded as a 1 in the corresponding array in step 112. Below threshold events are recorded as 0 in step 112. The oldest event is deleted in step 114. In step 116, each array is summed to determine whether an alarm has been detected. If an alarm is detected, then the network is notified in step 118. If no alarm is detected, the system goes back to sleep mode. Persons skilled in the art would appreciate that the flowchart in FIG. 1 may be modified within the scope of the disclosure by adding intermediate or terminal steps, removing certain steps, replacing certain steps with alternative steps, and changing the sequence of the steps, with the understanding that multiple steps may occur simultaneously.

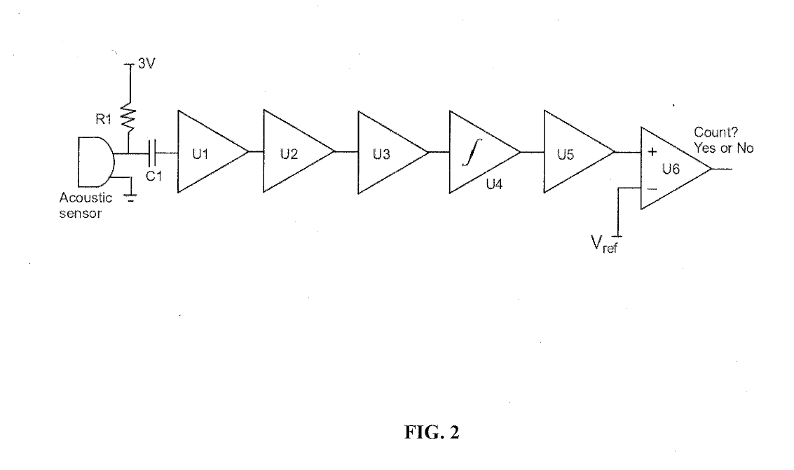

FIG. 2 is a block diagram depicting the sensor circuit operation. In FIG. 2, R1 is bias resistor; C1 is coupling capacitor; U1, U3 are amplifiers; U2 is a filter; U4 is an integrator for converting a rapidly fluctuating AC signal characterized by its root-mean-square (RMS) voltage to a steady DC voltage; U5 is a voltage comparator; and, V_{ref} indicates a voltage reference which can be equal to or less than V_{threshold}. An input voltage exceeding V_{threshold} causes the comparator output to signal TRUE (Yes). If this is not the case, the signal is FALSE (no).

When the MCU enters the active mode, it applies battery voltage (e.g., 3V) to the acoustic transducer (e.g. a microphone) and the following stages if present. Bias current is limited by R1. An example value of bias current is 0.1 mA. DC voltage is removed by C1 and the AC signal amplified by U1. Water leaks emit a distinct acoustic signal with high frequency audio and ultrasonic components in a specific spectral region. The sensor targets the 8-12 kHz subset of the broader 2-20 kHz acoustic emission spectrum. Stage U2 is a high-pass or bandpass filter set for this frequency range. This filtering provides an acceptable signal-to-noise ratio for reliable leak detection. The center frequency and width of the bandpass filter may vary, and do not limit the scope of the disclosure. Filtering may be implemented with electronic hardware or software in the MCU. With the background acoustics removed, amplification of the filtered signal is performed with stage U3.

The signal is next sent to an integration stage U4. Its function is to rectify the AC signal present in the filter passband. This can be accomplished with electronic hardware or software in the MCU. In a hardware embodiment, a standard half- or full-wave bridge rectifier circuit may be used. In another hardware embodiment, an RMS-DC converter can be used for this stage and has the advantages of speed, efficiency, and ability to process ultra-low voltages with excellent linearity. The tradeoff is the increased cost and additional power consumption of an integrated circuit compared to a simpler half-wave rectifier implemented with a diode and capacitor.

The quasi-DC output of the integrator is applied to one comparator terminal (U5). The second comparator terminal (U6) is held at a fixed reference voltage V_{threshold}, which determines the threshold for counting an acoustic event. The TRUE/FALSE (I/O) output of the comparator is recorded as a single element in the 1-dimensional counter array described above. V_{threshold} must be set to avoid false triggers yet provide needed sensitivity to detect low flow water leaks.

Rapid activation of audio electronics by the MCU causes turn-on transient noise that can propagate to the integration stage. This noise will contribute to the aggregate rectified signal level and thereby degrade the signal-to-noise ratio. This problem is overcome by preventing application of the signal to the integration stage until enough time has elapsed such that the turn-on transient noise has adequately decayed. This is done with a gating stage between stages U3 and U4 such as a unity-gain operational amplifier under the control of the MCU. Another embodiment is to use a gating signal to delay activation of U3. The longer the delay, the more immune the comparator is to turn-on noise, but at the expense of increased current consumption. Filter capacitors on the pulsed biased line help set the stabilization time constant. Another embodiment is an integration algorithm in software with appropriate turn-on time delay.

The sensor is placed in proximity to plumbing or plumbing fixtures, where it periodically monitors for high frequency signals associated with leaks. This acoustic signal may propagate many meters from the leak, both within the plumbing conduit and/or in free space. The closer the sensor is to the leak, the better its sensitivity. Detection will depend on i) the rate of flow, ii) the physical geometry of the emitting orifice, and iii) the acoustic quality of the path between leak and detector. Direct contact with pipe is not a requirement for effective sensor operation. Because the leak signals propagate with small loss in air, it is better to have the acoustic sensor mounted above the pipe (e.g., a PVC/plastic pipe that is part of the plumbing) than directly on it because it will hear water escaping outside the pipe, not within it. Leak rates from pressurized plumbing of the order 0.01 gallons/minute can be reliably detected at a leak-to-sensor separation distance >1 m.

The sensor is not limited to use with pressurized plumbing. It is anticipated that it will be sensitive to flowing gas in a pipe. It is also well suited for detecting anomalous acoustics originating from continuously running machinery. An example would be a bearing nearing its end of life or requiring lubrication, as this often manifests as a high frequency squealing sound that could be isolated from normal background noise in an industrial environment. Another application involves reciprocating equipment that falls out of balance over time. In this case, the active filter passband is configured to detect lower frequency acoustics (i.e. much lower than the normal rotation frequency) associated with an out-of-balance condition. Another application can be implemented with a band-pass filter designed for operation in the portion of acoustic spectrum produced by high-voltage corona discharge into it that may indicate impending failure in some electrical machinery.

In sum, the above system and method describe a water leak sensor including a battery power source, a micro-controller, an event counting algorithm that is optimized for extended battery life by holding all electronics with the exception of the micro-controller clock in an OFF state until an interrupt occurs to collect and interpret an acoustic signal, an acoustic transducer, a band-pass or high-pass filter to capture an acoustic signal with optimal signal-to-noise, an integrator/rectifier, and a comparator for signaling above threshold events that may represent the existence of an anomalous condition.

While the above method is capable of detecting the presence of plumbing leaks as small as 0.01 gallons per minute or even smaller, the sensitivity and overall efficacy can be enhanced by collecting additional information about the leak location. For example, the above method only indicates that a sensor is in proximity to and in the general vicinity of a leak, but it cannot specify its direction. With the use of a sound collection method, the above method can gain a directional capability. One or more sensors can then triangulate on the location of the leak source.

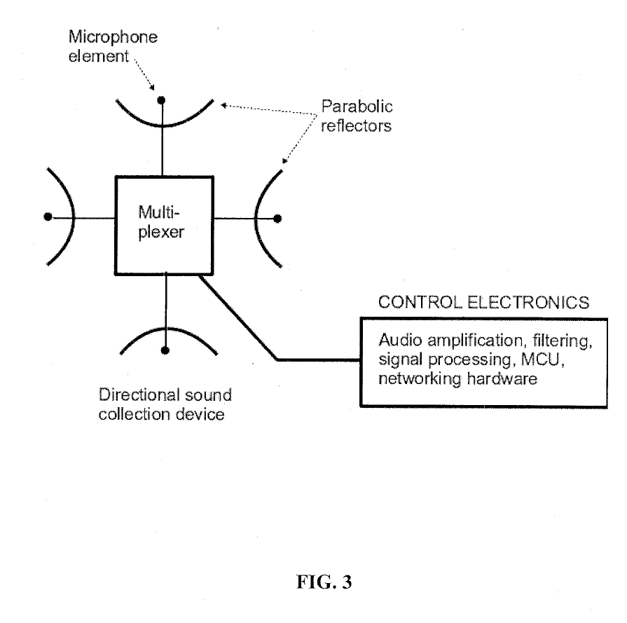

An embodiment of the present disclosure encompasses a method that employs directional sound collection devices. A directional sound collection device comprises a microphone or similar acoustic transducer placed at or near the focus of a reflector, for example a parabolic reflector. A block diagram of a method of directional sound collection is shown in FIG. 3. For purposes of illustration only, four directional sound collection devices are shown in FIG. 3. More or fewer could be implemented depending on the application. The four directional sound collection devices are oriented at 90° angles that independently monitor four perpendicular spatial directions. The angle between the collection devices may vary depending on the number of devices used. In one embodiment, an acoustic transducer is placed at the focus of an on-axis parabolic reflector. In another embodiment, an off-axis parabolic reflector focuses acoustic energy on the transducer. Higher/lower spatial resolution can be attained with more/fewer sound collectors. The collection cone of a parabolic reflector decreases (i.e. provides finer spatial resolution) as its aperture size (diameter) increases.

A parabolic reflector offers, among others, the following advantages:
Signal amplification (i.e. gain) occurs if the collection aperture is of the order of an acoustic wavelength. At the frequencies of interest (e.g. at 8-12 kHz) gain is provided with apertures >2 cm. Larger diameters provide more gain. This gain augments the gain of the audio amplifier electronic stage and improves sensitivity.
Lower frequency audio signals are preferentially rejected because the frequency (f) response of a parabolic reflector aperture scales as f². To illustrate, a 1 kHz signal will experience ˜50 dB amplitude reduction relative to a signal at 12 kHz, irrespective of dish diameter. Because most nominal indoor household activity generates acoustics at frequencies <10 kHz, the parabolic reflector can enhance the signal-to-noise ratio of the sensor and hence its reliability. Note that the system may be coupled with a motion detector to monitor nominal household water usage activity for the purpose of reducing or eliminating false alarms.
Directivity in acoustic signal collection is possible. The larger the parabolic reflector diameter, the narrower its angular resolution. This gives preferential enhancement of high frequency acoustic signals in the direction in which the parabolic collector is pointed.

The material from which the reflector is fabricated should efficiently reflect acoustic signals at the frequencies of interest; example materials are metal, plastic, glass, and ceramics. One embodiment of a multi-sensor housing is a monolithic structure with a fixture to locate each acoustic transducer (e.g. a microphone) at the focus of its associated on-axis parabolic reflector. Another embodiment uses a monolithic housing to form multiple off-axis parabolic reflectors that focus sound on corresponding microphone elements.

Because a pressurized plumbing leak is a sustained, long term event (e.g., lasting multiple minutes), simultaneous signal collection and processing of each sound collection device, while possible, is not necessary. Signals can be routed sequentially to the control module using an electronic multiplexer, as shown in FIG. 3. This eliminates the cost and complexity of separate control modules dedicated to each device. Multiplexer switching is controlled by the MCU, described above. There are no moving parts, which enhances reliability and minimizes manufacturing cost.

The control program may reside in the non-volatile flash memory of an MCU. Signals are routed sequentially to the control electronics with a multiplexer under the control of the MCU. To preserve battery life in non-wired applications, individual devices are activated for short periods (˜10 ms) to ascertain the presence of sufficiently large signals in the sensor passband. If a statistically significant number of above-threshold events are counted for an individual detector in a specified sampling window (e.g. multiple minutes), a pressurized water leak is determined to be present and an alarm condition is reported to the network.

The method places a sensor in proximity to but not in contact with pressurized plumbing. It periodically monitors for high frequency signals associated with leaks. This acoustic signal may propagate a long distance (e.g., many meters) from the leak, both within the plumbing conduit and/or in free space. The closer the sensor is to the leak, the higher the statistical detection probability. In addition, detection will depend on the rate of flow, the geometry of the orifice, and the acoustic quality of the path between leak and detector. Comparing statistics from multiple sound collection devices pointed in different directions allows triangulation to the leak source. Individual sound collection devices may be located on the same sensor unit, on multiple spatially-separated units, or both.

Another embodiment of this method includes multiple, spatially separated sensor units to provide a distributed mapping network for additional accuracy. Long-term data acquired from individual but otherwise identical sound collection devices contain statistical information that indicates the strength of the leak source and hence its separation from the detector. As an example, a detector that registers 90% detected events in a specified time window is in closer proximity to a leak than an identical detector that accumulates at a rate of 50% in the same time period. This information assists in triangulating to the leak source.

The device housing may contain a suite of sensors. It addition to an omni- or multi-directional acoustic water leak sensor, it can house a smoke detector, carbon dioxide detector, thermometer, humidity meter, motion detector, and glass breakage detector along with other automated home and building sensors.

To summarize, disclosed is a water leak sensing method that includes one or more acoustic transducers, one or more sound collection devices including on-axis or off-axis parabolic reflectors to focus acoustic energy on the acoustic transducer(s) to discern the direction of the leak source, an electronic multiplexer in which electrical signals from multiple sound collection devices are routed to the control electronics, and control electronics including a micro-controller, an event counting algorithm that is optimized for extended battery life by holding all electronics with the exception of the micro-controller clock in an OFF state until an interrupt occurs to collect and interpret an acoustic signal, a high-pass or band-pass filter designed to capture an acoustic signal with optimal signal-to-noise, an integrator/rectifier, and a comparator for signaling above threshold events that may represent the existence of an anomalous condition.

Persons skilled in the art would readily recognize that the above described methods may also include sensors for other anomalous conditions that include but are not limited to smoke, carbon monoxide, excess humidity, motion, temperature, and glass breakage. Also, not only water leak, but other liquid or gas leaks can be detected.

Although the present disclosure has been particularly described with reference to the preferred embodiments thereof, it should be readily apparent to those of ordinary skill in the art that changes and modifications in the form and details may be made without departing from the spirit and scope of the disclosure. For example, the steps of the disclosed methods can be performed in a different order and still achieve desirable results. It is intended that the appended claims encompass such changes and modifications.

1. A system for detecting fluid leakage from stand-off distances, the system comprising:
one or more acoustic sensors for collecting acoustic signals from a location experiencing fluid leakage, wherein the acoustic sensors are not in direct contact with the fluid; and
a micro-controller that periodically operates an electronic circuitry controlled by an event-counting algorithm, wherein the event counting algorithm records an event when the acoustic signal produces a voltage in the electronic circuitry that is higher than a predetermined threshold voltage,
wherein the electronic circuitry comprises a filter that separates undesired noise from the acoustic signal collected by the acoustic sensors to determine if the filtered acoustic signal contains signature frequencies associated with a leak.

2. The system of claim 1, wherein the specific fluid is water and the frequency range associated with water leakage is 8-12 kHz.

3. The system of claim 1, wherein the periodicity of the microcontroller's operation is determined by the event-counting algorithm to optimize life of a power source included in the system.

4. The system of claim 3, wherein except the microcontroller's clock, all components of the electronic circuitry are in sleep mode in between the microcontroller's operative periods.

5. The system of claim 1, wherein the electronic circuitry further comprises:
an amplifier that amplifies the acoustic signal in one or more stages;
an integrator that converts the filtered acoustic signal to a steady DC voltage; and
a comparator that compares the steady DC voltage with a reference voltage which is less than or equal to the predetermined threshold voltage.

6. The system of claim 5, wherein an array event is recorded as 0 or 1 every time a voltage comparison shows that the steady DC voltage is lower or higher, respectively, than the predetermined threshold voltage.

7. The system of claim 6, wherein a sufficient number of recorded array events corresponding to acoustic signals producing voltages higher than the predetermined threshold voltage identifies an alarm condition, wherein a signal is generated and communicated to a surveillance network along with notification of an event indicating a fluid leakage.

8. The system of claim 5, wherein the integrator comprises a best mode rectifier in the form of a root-mean-square (RMS) DC converter.

9. The system of claim 5, wherein the integrator comprises a rectifier in the form of an audio transformer and full-wave bridge rectifier comprising a plurality of diodes and an integrating capacitor.

10. The system of claim 5, wherein the integrator comprises a rectifier in the form of a half-wave rectifier comprising a diode and an integrating capacitor.

11. The system of claim 1, wherein the acoustic sensor comprises a best mode electret condenser microphone.

12. The system of claim 1, wherein the acoustic sensor comprises a MEMS microphone.

13. The system of claim 1, wherein the acoustic sensor comprises a piezoelectric transducer.

14. The system of claim 1, wherein the acoustic sensor comprises at least one sound collection device comprising a parabolic reflector with a acoustic transducer located at a focal point of the parabolic reflector.

15. The system of claim 14, wherein the acoustic sensor comprises more than one sound collection devices for the purpose of discerning the direction of a source of fluid leakage.

16. The system of claim 15, wherein a triangulation method is used to discern the direction of the source of the fluid leakage based on strength of acoustic signal collected by the more than one sound collection devices.

17. The system of claim 15, wherein acoustic signals from multiple sound collection devices are routed to the electronic circuitry by an electronic multiplexer.

18. The system of claim 17, wherein the electronic circuitry comprises separate channels for analysis of different acoustic spectral regions.

19. The system of claim 18, wherein a spectral region indicating nominal household water usage activity does not trigger a leakage event notification.

20. The system of claim 1, wherein the system includes one or more ultrasonic emitter-detector pairs to generate and detect acoustic reflections from objects and structures in an environment proximate to the fluid's flow path.
